(19) United States
(12) Patent Application Publication
(10) Pub. No.: US 2009/0027830 A1
(43) Pub. Date: Jan. 29, 2009

(54) Non-Aqueous Capacitor and Method for Manufacturing the Same

(76) Inventor: Shinji Naruse, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 12/087,053

(22) PCT Filed: Dec. 21, 2006
(86) PCT No.: PCT/JP2006/326174

§ 371 Date: Jun. 25, 2008

(30) Foreign Application Priority Data
Dec. 28, 2005 (JP) 2005-379916
Mar. 17, 2006 (JP) 2006-073898

(51) Int. Cl. H01G 9/145

(52) U.S. Cl. 361/503; 29/25.03

(57) ABSTRACT

This invention provides a non-aqueous capacitor having high voltage resistance, energy density and power density, which comprises an electrode unit composed of collectors, electrodes and separators, and an electrolytic solution, which are contained and sealed in a case, in which each of the collectors, electrodes and separators is made of the materials having a melting point or pyrolysis-initiating temperature (where melting point is not expressed) not lower than 280° C., and the electrode unit is dried after its assembling, at a temperature not lower than the lowest of the melting points or pyrolysis-initiating temperatures of the materials constituting the electrode unit, by 100° C.

### TECHNICAL FIELD

This invention relates to a non-aqueous capacitor which uses an organic electrolytic solution as electrolytic solution, among electrochemical capacitors making use of electricity-storing electric double layer discovered by Helmholtz in 1879, in which carbonaceous substances such as active carbon, carbon foam, carbon nanotube, polyacene, nanogate carbon or the like are used as their electrodes; capacitors utilizing also pseudo-capacity accompanied by oxidation-reduction reaction, in which metal oxide, conductive polymer, organic radical and the like are used as the electrode; and hybrid capacitors in which batteries are utilized as the electrodes at one side.

### BACKGROUND ART

As symbolized by recent progress in portable communication devices or high-speed information-processing devices, reduction in size and weight and enhancement in technical advantages of electronics are remarkable. In particular, much is expected of small size, light weight, high capacity and long storage-resistant high performance capacitors, and their broad applications are undertaken and their component development is under rapid progress. Because capacitors in general have longer life and enable rapid charge and discharge compared to batteries, they are expected to be useful as secondary batteries for electric cars, hybrid cars and fuel-cell cars in these years, besides their conventional utilities for smoothing power sources, noise absorption and the like. As such a capacitor, JP 2000-243453A discloses the one having a structure that a pair of electrodes are immersed in non-aqueous electrolytic solution. This kind of non-aqueous capacitors are classified into the following two types.

(1) A non-aqueous capacitor manufactured by assembling collectors, electrodes and separators, which have been each separately dried by heating under reduced pressure, to prepare an electrode unit, inserting the electrode unit into a case, impregnating the unit with an electrolytic solution under reduced pressure, and then sealing the case.

This manufacturing method is subject to such problems as: because of the necessity to dry each of the collectors, electrodes and separators by heating under reduced pressure, the manufacture is cumbersome and plural drying facilities are required with a wide space for their operation; and due to the highly hygroscopic property of active carbon known as an electrode-constituting element, the electrodes re-absorb moisture during the assembling after the heating for reduced pressure-drying, inviting reduction in voltage resistance.

(2) A non-aqueous capacitor manufactured by assembling collectors, electrodes and separators, drying the assemblage by heating under reduced pressure, inserting the resulting electrode unit into a case, impregnating the unit with a non-aqueous electrolytic solution under reduced pressure and sealing the case.

This manufacturing method has the advantages of simplifying the manufacturing steps because the electrode units are dried by heating under reduced pressure after having been assembled, and of not requiring a wide space because the number of drying apparatuses can be reduced. On the other hand, the temperature for drying by heating under reduced pressure after the assembling must not be higher than the low melting point and thermal decomposition temperature of, for example, polyvinylidene fluoride contained in binders used for assembling the electrode units or of cellulose, polyethylene, polyethylene terephthalate and the like which constitute the separators, and removal of their water content becomes insufficient. This gives rise to the problem that the resulting capacitors cannot have sufficient voltage resistance, energy density and power density.

JP 2001-185455A discloses, with the view to sufficiently remove water content of the electrode units, constructing the separators in electrode units of non-aqueous capacitors, using resins of high softening temperature, and drying the assembled electrode units at a temperature lower than the softening temperature. This laid-open Official Gazette, however, fails to explicitly disclose the relevancy between the drying temperature which assures removal of water content of the electrode units and temperature characteristics of the materials constituting the electrode units. Hence, the intended capacitor characteristics may not be obtained depending on the constituent materials of the non-aqueous capacitors.

### DISCLOSURE OF THE INVENTION

An object of the present invention is to solve the problems indicated in the above and to provide capacitors of high voltage resistance, energy density and power density.

We have ardently advanced our research work with the view to develop capacitors which withstand a large quantity of electric current in consequence of the higher capacity and larger power, and give high voltage resistance, energy density and power density, and now come to discover that the object can be accomplished by using, as the constituent materials of the electrode units, those having high melting point or pyrolysis-initiating temperature; and by drying the electrode units at specific temperatures after their assembling. The present invention is whereupon completed.

Thus the present invention provides a non-aqueous capacitor comprising an electrode unit composed of collectors, electrodes and separator(s), and an electrolytic solution, which are contained and sealed in a case, characterized in that each of the collectors, electrodes and separator(s) is made of the materials having a melting point or pyrolysis-initiating temperature (when no melting point is expressed) not lower than 280° C., and that the electrode unit is dried after its assembling, at a temperature not lower than the lowest of the melting points or pyrolysis-initiating temperatures of the materials constituting the electrode unit, by 100° C.

The present invention also provides a method of manufacturing a non-aqueous capacitor comprising an electrode unit which is composed of collectors electrodes, electrodes and separator(s), the method being characterized by making each of the collectors, electrodes and separators of the materials having a melting point or pyrolysis-initiating temperature (where melting point is not expressed) not lower than 280° C., drying the electrode unit after its assembling at a temperature not lower than the lowest of the melting points or pyrolysis-initiating temperatures of the materials by 100° C., putting the dried electrode unit in a case, pouring an electrolytic solution thereinto and sealing the case.

The capacitor of the present invention can have a high voltage resistance, energy density and power density, because its water content is sufficiently removed due to the use of materials having melting points or pyrolysis-initiating temperatures (where melting point is not expressed) not lower than 280° C., as the materials for making the three elements constituting the electrode unit, collector, electrode and separator; and by drying the electrode unit after its assembling, at a temperature not lower than the lowest of the melting points or pyrolysis-initiating temperatures (where melting point is not expressed) of the materials constituting the electrode unit, by 100° C.

Hereinafter the non-aqueous capacitor of the present invention is explained in further details.

In the present invention, “melting point” signifies the melting point measured by thermal measurement methods such as DSC (Differential Scanning Carolimetry), DTA (Differential Thermal Analysis) and the like. Polymers in general exhibit broad range of melting behaviors, reflecting their heterogeneous molecular weight components and differences in degrees of crystallization. In the present invention, the temperature corresponding to the endothermic peak in DSC analysis is indicated as the melting point. Also “pyrolysis-initiating temperature” is the lowest temperature at which a substance under heating decomposes and changes into a substance of less mass, which is usually measured with TGA (thermogravimetric analyzer), as the temperature at which decrease in mass of a substance begins, when the substance is heated at a constant temperature rise rate.

### Collector:

The collector which constitutes the electrode unit in the invention is made of material(s) having a melting point or pyrolysis-initiating temperature (where melting point is not expressed) not lower than 280° C. While there is no particular qualitative limitation for the materials so long as they are electroconductive, those having the melting point or pyrolysis-initiating temperature (where melting point is not expressed) not lower than 320° C. are preferred in respect of productivity. As the materials for the collector, for example, metallic thin plate such as of aluminum, platinum and the like can be used, which preferably contain the lead-in wire part.

### Electrode:

The electrode which constitutes the electrode unit in the invention also is made of material(s) having a melting point or pyrolysis-initiating temperature (where melting point is not expressed) not lower than 280° C. While there is no particular qualitative limitation for the materials so long as they are electroconductive, those having the melting point or pyrolysis-initiating temperature (where melting point is not expressed) not lower than 320° C. are preferred in respect of productivity. As the chief ingredient of the materials for making the electrode, for example, carbonaceous materials such as active carbon, carbon foam, carbon nanotube, polyacene, nanogate carbon and the like, utilizing electricity-storing electric double layer discovered by Helmholtz in 1879, or metal oxide, conductive polymer, organic radical and the like utilizing pseudo-capacity accompanied by acid-reduction reaction can be named. As the electrodes at one side, those of batteries may also be used. The electrode can be manufactured, for example, by mixing above chief ingredient with electroconductive agent, binder and the like, where necessary, and molding the mixture by kneading, powder compressing, rolling, coating, sintering, doctor blade application, wet-forming and the like.

The electroconductive agent is made of a material having the melting point or pyrolysis-initiating temperature (where melting point is not expressed) not lower than 280° C. While there is no qualitative limitation for the agent so long as it is electroconductive, one having the melting point or pyrolysis-initiating temperature (where melting point is not expressed) not lower than 320° C. is preferred in respect of productivity, examples of which include carbonaceous materials such as carbon black, acetylene black, Ketchen Black or the like.

The binder also is made of a material having the melting point or pyrolysis-initiating temperature (where melting point is not expressed) not lower than 280° C. So long as the binder can bind the chief ingredient, quality of its material is subject to no particular limitation. Whereas, from the viewpoint of productivity, the material preferably has the melting point or pyrolysis-initiating temperature (where melting point is not expressed) not lower than 320° C. Specific examples of such material include aramid, wholly aromatic polyester, wholly aromatic polyazo compound, wholly aromatic polyesteramide, wholly aromatic polyether, polyether ether ketone, polyphenylene sulfide, poly-p-phenylenebenzobisthiazole, polybenzoimidazole, poly-p-phenylenebenzobis-oxazole, polyamidimide, polyimide, bismaleimidotriazine, polyaminobismaleimide, polytetrafluoroethylene, ceramic, alumina, silica, alumina-silica, glass, rock wool, silicon nitride and the like. In particular, aramid and polytetrafluoroethylene which exhibit good chief ingredient-binding ability are preferably used.

### Separator:

As the separator constituting the electrode unit according to the present invention, those made of the materials having the melting point or pyrolyis-initiating temperature (where melting point is not expressed) not lower than 280° C., which are ion-permeable and free of such problems as short-circuit are used. While quality of such materials are not particularly limited, those having the melting point or pyrolysis-initiating temperature (where melting point is not expressed) not lower than 320° C. are preferred from the viewpoint of productivity. Specific examples of such material include aramid, wholly aromatic polyester, wholly aromatic polyazo compound, wholly aromatic polyesteramide, wholly aromatic polyether, polyether ether ketone, polyphenylene sulfide, poly-p-phenylenebenzobisthiazole, polybenzoimidazole, poly-p-phenylenebenzobisoxazole, polyamidimide, polyimide, bismaleimidotriazine, polyaminobismaleimide, polytetrafluoroethylene, ceramic, alumina, silica, alumina-silica, glass, rock wool, silicon nitride and the like. In particular, use of the aramid thin sheet material as disclosed in JP 2005-307360A as the separator shows the effect of increasing the power density and, therefore, is preferred. The aramid thin sheet material is constituted of the two components of aramid fibers and fibrillated aramid, or of said two components and aramid fibrid, which has the internal resistance as expressed by the following equation (1) of not higher than 250 μm and Oken-type gas permeability of at least 0.5 sec./100 cm³:

$$\frac{( internal resistance ) = ( electroconductivity of electrolytic solution )}{( electroconductivity of electrolytic solution \text{-} injected sepatator )} \times ( thickness of separator ) . \qquad equation ( 1 )$$

Here the “electrolytic solution” signifies the liquid formed of a solvent in which an electrolyte is dissolved and as such, those described later can be used. “Electroconductivity of electrolytic solution-injected separator” signifies the electroconductivity as calculated from the AC impedance measured by sandwiching the electrolytic solution as injected in the separator between two sheet electrodes. While the AC impedance-measuring frequency is not particularly limited, the range of 1 kHz-100 kHz is preferred.

### Electrode Unit:

The electrode unit in the present invention is an assembly of above-described collectors, electrodes and separator(s), and its construction is not particularly limited. For example, a laminate of collector electrode/separator/electrode/collector by the order stated; laminate of electrode/collector/electrode/separator/electrode/collector/electrode/separator; a laminate formed by repeating such laminations as above; or those laminates wound up into rolls; can be used. Individual members forming such laminates may be adhered in advance with an adhesive or the like. The composite sheet as described in JP 2005-311190A may also be used, which is composed of electrode elements and separators, the separator having a volume specific resistance of at least 10¹⁰ Ωcm.

### Electrolytic Solution:

The electrolytic solution used in the invention for impregnating the above electrode unit is a liquid formed of a solvent in which an electrolyte is dissolved.

There is no particular limitation as to the solvent, electrolyte and concentration of the electrolyte. Examples of the solvent include ethylene carbonate, propylene carbonate, dimethyl carbonate, diethyl carbonate, ethylmethyl carbonate, butylene carbonate, glutaronitrile, adiponitrile, acetonitrile, methoxyacetonitrile, 3-methoxypropionitrile, γ-butyrolactone, γ-valerolactone, sulfolane, 3-methylsulfolane, nitroethane, nitromethane, trimethyl phosphate, N-methyloxazolidinone, N,N-dimethylformamide, N-methylpyrrolidone, dimethylsulfoxide, N,N′-dimethylimidazolidinone, amidine, water, and mixtures of two or more of the foregoing.

As the electrolyte, ionic substances, for example, following combinations of cations with anions can be used:

1) cation: quaternary ammonium ion, quaternary phosphonium ion, lithium ion, sodium ion, ammonium ion, hydrogen ion and mixtures of the foregoing,
2) anion: perchlorate ion, borofluoride ion, hexafluorophosphate ion, sulfate ion, hydroxide ion and mixtures of the foregoing.

Also such ionic liquid as imidazolium salts which have low melting points and are liquid even at ambient temperature can be used as the electrolyte. Because ionic liquid's vapor pressure is nearly zero, it can be expected to increase life of the capacitors, and there is also a possibility of imparting fireproof property to the capacitors.

### Driving of the Electrode Units:

According to the invention, the electrode units assembled as described above are dried at temperatures not lower than the lowest of the melting points or pyrolysis-initiating temperatures (where melting point is not expressed) of the materials used in those collectors, electrodes and separators constituting the electrode units, by 100° C. From the viewpoint of shortening the manufacture time of the capacitors, higher drying temperatures are preferred, and desirably the drying temperature is not lower than the lowest of the melting points or pyrolysis-initiating temperatures (where melting point is not expressed) by 50° C. As to the upper limit of the drying temperature, the higher the drying temperature, the shorter the manufacture time. Whereas, as the drying temperature approaches the melting point or pyrolysis-initiating temperature (where melting point is not expressed) of the material, the assembled electrode unit may be deformed and cause such problems as deterioration in characteristics like the capacity as a capacitor and impedance. Thus, favorable drying temperature is within a range not higher than 30° C. below the lowest of the melting points or pyrolysis-initiating temperatures (where melting point is not expressed) of the materials used in the collectors, electrodes and separators which constitute the electrode unit, but not lower than the said lowest temperature by 100° C. From the viewpoint of manufacture time, particularly preferable range is not higher than 30° C. below the lowest temperature but not lower than the lowest temperature by 50° C.

It is desirable for the atmosphere at the drying time to have an as little as possible water content. Specifically, drying of the electrode units can be conducted, for example, in a flowing inert gas such as dry argon, or under reduced pressure. In particular, reduced pressure-drying is preferred for removing the water content deposited on the electrode unit surface to the maximum and also for lowering boiling point of the water. The pressure of the atmosphere is preferably not higher than 1 Torr.

The drying time is not subject to any particular limitation, so long as it falls within the range which enables to accomplish the targeted voltage resistance, energy density and power density. Whereas, from the viewpoint of productivity, within 24 hours, in particular, within 15 hours, is preferred.

Also the degree of drying is preferably such that the water content of the electrode after the drying is not more than 1,700 ppm. For further drastically improving the voltage resistance, energy density and power density, it is normally desirable to reduce the water content to not higher than 1,350 ppm, in particular, not higher than 1,000 ppm. Hence, drying of the electrode unit is desirably conducted under the above-described conditions, until the water content of the electrode after the drying becomes no higher than the above limit.

### Case:

The case in the present invention is subject to no particular limitation, so long as it can contain the electrode unit and electrolytic solution and can be sealed. For example, an aluminum can case, aluminum laminate case, aluminum coin case and the like can be used.

### Capacitor:

Upon putting the above dried electrode unit in the case, pouring an electrolytic solution thereinto and sealing the case, a capacitor according to the present invention is obtained. The electrolytic solution is preferably impregnated under reduced pressure.

Thus obtained capacitor of the present invention can have the capacity retention of generally at least 50%, in particular, at least 70%, after being kept in floating condition under application of 2.8 V at 70° C. for 500 hours.

### EXAMPLES

Hereinafter the present invention is more specifically explained, referring to Examples. These Examples are given simply for exemplification, and are in no way to restrict the scope of the present invention.

### Example 1

### Preparation of an Electrode

Using the electrode materials such as steam-activated active carbon as the chief ingredient, polytetrafluoroethylene resin (PTFE) as the binder and Ketchen Black (KB) as an electric conductor, a sheet having the composition of the active carbon/PTFE/KB=86/6.5/7.5 (wt %) was prepared to provide a 115 μm-thick electrode having a density of 0.6 g/cm³.

### <Preparation of an Electrode Unit>

The above electrode which was punch-cut to a size of 50×30 mm was adhered to a collector aluminum foil (40 μm in thickness) with an electroconductive paint (phenolic resin-made) to provide an electrode-collector composite.

Following the method of Example 2 in JP 2005-307360A, a separator (basis weight, 24.4 g/m²; thickness, 46 μm; density, 0.53 g/cm³) formed of m-aramid and p-aramid was prepared and inserted between the above composites of a pair of positive and negative poles, to provide an electrode unit.

### <Drying of the Electrode Unit>

The material having the lowest melting point or pyrolysis-initiating temperature (where no melting point was expressed) among the materials constituting the above electrode unit was polytetrafluoroethylene whose melting point was 327° C. The electrode unit was reduced pressure-dried for 12 hours, under the conditions of 280° C. in temperature and not higher than 1 Torr in pressure.

### <Manufacture of a Capacitor>

In a dry atmosphere, so dried electrode unit was encased in aluminum prism wrapping. Three sides of the wrapping were sealed and into which 1.5M TEMABF₄/PC (a solution of triethylmethylammonium tetrafluoroborate in propylene carbonate) was poured to cause impregnation under reduced pressure. Thereafter the remaining one side was sealed under reduced pressure to provide a capacitor of the construction as shown in the following Table 1.

TABLE 1
Capacitor Construction

| | | | |
|---|---|---|---|
| Electrode | composition | wt % | active carbon/KB/PTEE = |
| | | | 86/6.5/7.5 |
| | thickness | μm | 115 |
| | density | g/cm³ | 0.6 |
| | dimensions | mm × mm | 50 × 30 |
| | (length × width) | | |
| Collector | material | | aluminum |
| | thickness | μm | 40 |
| Separator | composition | wt % | m-aramid/p-aramid = |
| | | | 50/50 |
| | basis weight | g/m² | 24.4 |
| | thickness | μm | 46 |
| | density | g/cm³ | 0.53 |
| | dimensions | mm × mm | 53 × 33 |
| | (length × width) | | |
| Electrolytic | composition | | 1.5M-TEMABF₄/PC |
| Solution | | | |
| Case | material | | aluminum |
| | form | | laminate |

### <Property Evaluation>

Initial properties and floating properties of above capacitor were measured by the following methods.

### 1) Initial Charge and Discharge Characteristics

As the initial properties, the charge and discharge measurements were conducted at 1C rate in the initial stage, and impedance measurement was conducted to calculate the resistance.

The measuring conditions were as follows:

initial capacity measurement (25° C.)
charge: CCCV 4.2 mA (1C), 2.8 V-2 hrs.(*)
discharge: CC 4.2 mA (1C), 0.01 V(**)
(*) CCCV: Constant-Current Constant-Voltage
(**): Constant-Current

Impedance measurement (25° C.)
measured condition: at the end of discharge
measuring frequency: 20,000 Hz-0.1 Hz
amplitude (ΔE): 10 mV.

### 2) Floating Charge Characteristics

As the floating charge characteristics, the tested capacitors were kept for 500 hours in 70° C. environment in the state of being applied a charge of 2.8 V. At the end of the 500 hours' floating, capacity was confirmed and impedance was measured to calculate the resistance. The measuring conditions were as follows:

floating test
charge: 2.8 V-500 hrs. (70° C.)

capacity measurement (25° C.)
charge: CCCV 4.2 mA (1C), 2.8 V-2 hrs.
discharge: CC 4.2 mA (1C), 0.01 V

Impedance (25° C.)
measured condition: at the end of discharge
measured frequency: 20,000 Hz-0.1 Hz
amplitude (ΔE): 10 mV.

### Comparative Example 1

A capacitor was prepared by the same method to that of Example 1 except that a cellulose separator (basis weight, 19.7 g/m²; thickness, 42 μm; density, 0.47 g/cm³) for commercially available capacitors was used and that the electrode unit was dried at the temperature of 150° C. The capacitor's properties were measured in the same manner as in Example 1. The results are shown in the following Table 2.

TABLE 2

| | | | | | | Comparative |
|---|---|---|---|---|---|---|
| Measured Item | | | Unit | | Example 1 | Example 1 |
| Capacity | | | mAh | initial stage | 4.30 | 4.21 |
| | | | mAh | 250 hrs. | 4.26 | 1.76 |
| | | | mAh | 500 hrs. | 3.07 | 0.88 |
| Resistance | 20000 | Hz | Ω | initial stage | 0.21 | 0.16 |
| | | | Ω | 250 hrs. | 0.34 | 1.42 |
| | | | Ω | 500 hrs. | 0.85 | 5.56 |
| | 0.1 | Hz | Ω | initial stage | 0.48 | 0.4 |
| | | | Ω | 250 hrs | 0.69 | 2.78 |
| | | | Ω | 500 hrs. | 1.78 | 11.12 |
| Capacity Retention | | | % | 250 hrs. | 99.1 | 41.8 |
| | | | % | 500 hrs. | 71.4 | 20.9 |
| Resistance | 20000 | Hz | % | 250 hrs. | 161.9 | 887.5 |
| Increase | | | % | 500 hrs. | 404.8 | 3475.0 |
| Ratio | 0.1 | Hz | % | 250 hrs. | 143.8 | 695.0 |

| | | | |
|---|---|---|---|
| % | 500 hrs. | 370.8 | 2780.0 |

As is clear from Table 2, the capacitor of Example 1 of this invention showed better floating charge characteristics than those of the capacitor of Comparative Example 1. The capacitor according to the present invention was confirmed to have a capacity retention, after being kept in floating condition under application of 2.8 V at 70° C. for 500 hours, of at least 70%, and its resistance increase ratio was suppressed to be within 500%, substantiating an improvement in its voltage resistance. This is considered to be the result of sufficient removal of water content by the high temperature-drying of the electrode units, resulting in suppression of gas generation by decomposition of electrolytic solution and/or electrolysis of water.

Furthermore, based on the above results, the energy densitiy and power density of the capacitor of Example 1 and those of Comparative Example 1 were calculated according to the following equations (2) and (3). The results are shown in Table 3:

(energy density)=0.5×(capacity)×(voltage)² equation (2)

(power density)=0.25×(voltage)²/(impedance) equation (3)

TABLE 3

| | | | | Comparative |
|---|---|---|---|---|
| Item | Unit | | Example 1 | Example 1 |
| Energy Density | % | 500 hrs. | 349 | 100 |
| Power Density | % | 500 hrs. | 625 | 100 |

The impedance was calculated based on the value at 0.1 Hz.

As is clear from Table 3, the capacitor of Example 1 showed remarkable improvement in both energy density and power density.

Water content of those electrodes was measured with EMD-WA1000SW (manufactured by ESCO, Ltd.). That is, steam-activated active carbon was dried under the conditions of Example 1 or those of Comparative Example 1, allowed to cool off for an hour while maintaining vacuum condition, raised of its temperature to 700° C. at a temperature rise rate of 60° C./min. and maintained at said temperature for further 8 minutes. From the quantities of released water at the temperature-raising time and maintenance time, water content of the active carbon was calculated. As the result, when the drying conditions of Comparative Example 1 were adopted, water content of the active carbon was 2300 ppm. By contrast, it was 1100 ppm, when the drying conditions of Example 1 were used. Multiplying these calculated values by the ratio of the active carbon in the electrodes (86%), the water content of the electrode under the drying conditions of Comparative Example 1 became 1978 ppm, while that under the drying conditions of Example 1 was 946 ppm. It is thus recognized that the water content was substantially removed under the drying conditions of Example 1, and that the removal of water content by high temperature-drying is effective for improving energy density and power density.

1. A non-aqueous capacitor comprising an electrode unit composed of collectors, electrodes and separators, and an electrolytic solution, which are contained and sealed in a case, characterized in that each of the collectors, electrodes and separators is made of the material(s) having a melting point or pyrolysis-initiating temperature (where melting point is not expressed) not lower than 280° C., and that the electrode unit is dried after its assembling, at a temperature not lower than the lowest of the melting points or pyrolysis-initiating temperatures of the materials constituting the electrode unit, by 100° C.

2. A non-aqueous capacitor according to claim 1, in which each of the collectors, electrodes and separators is made of the materials having a melting point or pyrolysis-initiating temperature (where melting point is not expressed) not lower than 320° C.

3. A non-aqueous capacitor according to claim 1, in which the electrode unit is the one dried after its assembling, at a temperature not lower than the lowest of the melting points or pyrolysis-initiating temperatures (where melting point is not expressed) of the materials constituting the electrode unit by 50° C.

4. A non-aqueous capacitor according to claim 1, in which the drying temperature is within a range not higher than 30° C. below the lowest of the melting points or pyrolysis-initiating temperatures (where melting point is not expressed) of the materials used in the collectors, electrodes and separators which constitute the electrode unit, but not lower than the said lowest temperature by 100° C.

5. A non-aqueous capacitor according to claim 4, in which the drying temperature is within a range not higher than 30° C. below the lowest of the melting points or pyrolysis-initiating temperatures (where melting point is not expressed) of the materials used in the collectors, electrodes and separators which constitute the electrode unit, but not lower than the said lowest temperature by 50° C.

6. A non-aqueous capacitor according to claim 1, in which the water content of the electrode after the drying is not more than 1700 ppm.

7. A non-aqueous capacitor according to claim 1, which has a capacity retention, after being kept in floating condition at a voltage of 2.8 V and a temperature of 70° C. for 500 hours, of at least 70%.

8. A method of manufacturing a non-aqueous capacitor comprising an electrode unit which is composed of collectors, electrodes and separators, the method being characterized by making each of the collectors, electrodes and separators of the materials having a melting point or pyrolysis-initiating temperature (where melting point is not expressed) not lower than 280° C., drying the electrode unit after its assembling at a temperature not lower than the lowest of the melting points or pyrolysis-initiating temperatures of the materials by 100° C., putting the dried electrode unit in a case, pouring an electrolytic solution thereinto and sealing the case.

9. The method according to claim 8, in which the drying is carried out until water content of the electrode becomes no more than 1700 ppm.
